(19) United States
(12) Patent Application Publication
(10) Pub. No.: US 2007/0139380 A1
(43) Pub. Date: Jun. 21, 2007

(54) Hand-held combined mouse and telephone device

(76) Inventor: Chiang-Shui Huang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/305,262

(22) Filed: Dec. 19, 2005

(51) Int. Cl. G09G 5/08

(52) U.S. Cl. 345/166

(57) ABSTRACT

The present invention provides a hand-held combined mouse and telephone device functioned to be operated in a mouse mode for a computer system and a telephone mode for a telephone telecommunication. The hand-held combined mouse and telephone device comprises a telephone body, an optical cursor detection unit, a telecommunication processor, a plurality of mouse buttons and a mouse interface circuitry. The optical cursor detection unit detects and transmits the mouse displacement signals to the mouse interface circuitry when the telephone body is placed and moved on a pad. The telecommunication processor disposed inside the telephone body connects to the mouse interface circuitry and controls the mouse interface circuitry to be switched on and off. Therefore, the hand-held combined mouse and telephone device is selected by users to be operated in a mouse mode or a telephone mode.

### BACKGROUND OF THE INVENTION

1. Field of the Invention

The present invention relates generally to a mobile telephone and a computer mouse, and more especially to a hand-held device combining the mobile telephone and the computer mouse.

2. The Related Art

A mouse enables a user to control the position of a cursor on a computer display. Recently the mouse has become a normal and indispensable peripheral device to facilitate computer input for a desktop computer. In consideration of portability and convenience, however, a notebook computer is provided with a touch pad integrated therewith, instead of the mouse, to control the cursor on the computer display. The touch pad controls the cursor on the notebook computer screen through press and movement manipulation with fingers on the pad. Compared with the mouse, obviously, the touch pad of the notebook computer can't be freely and flexibly controlled as the mouse, so the user can't enjoy convenient cursor controlling manipulation on the touch pad. Thus, it requires the user to carry an additional mouse together with the notebook computer for convenient controlling the cursor on the notebook computer display, which makes the user's baggage bulky and heavy.

At present, a mobile phone has become an indispensable device for a user to convenient communication. The mobile phone has advantages of convenient portability and expansibility. The mobile phone and the mouse are found in close proximity to one another, therefore, it is possible to combine the mobile telephone and the mouse together as a single device for convenient carrying and being freely manipulated as a mouse.

### SUMMARY OF THE INVENTION

It is an object of the present invention to provide a hand-held combined mouse and telephone device which incorporates a mouse and a telephone into a single, integrated computer peripheral device, for convenient carrying without occupying extra space.

It is another object of the present invention to provide a hand-held combined mouse and telephone device which is able to operationally function either as a telephone for telecommunication and as a mouse for convenient cursor controlling, in conformance with convenient selections of operational modes by a user.

To fulfill the above objects, the hand-held combined mouse and telephone device of the present invention comprises a telephone body, an optical cursor detection unit, a plurality of mouse buttons and a mouse interface circuitry. The telephone body has a telecommunication processor and a keypad. The telecommunication processor controls and processes telephone signals. The keypad generates input signals in response to manual entry on the keypad. The optical cursor detection unit is disposed on back of the telephone body to detect the displacement signal of the telephone body when the telephone body is placed and moved on a pad. The mouse buttons are positioned on the telephone body for generating input signals corresponding to manual press on the mouse buttons. The mouse interface circuitry is disposed inside the telephone body. The mouse interface circuitry connects to the optical cursor detection unit, the mouse buttons, the telecommunication processor and a host computer, respectively. The displacement signals from the optical cursor detection unit and the input signals from the mouse buttons are transmitted through the mouse interface circuitry to a host computer. The telecommunication processor controls the mouse interface circuitry to be switched on and off so as to control the transmission of the displacement signals from the optical cursor detection unit and the input signals from the mouse buttons to the host computer, thereby controlling the cursor displacement on the computer display.

As mentioned above, the present invention provides a hand-held combined mouse and telephone device capable of being operated as a telephone as well as a mouse. The hand-held combined mouse and telephone device combines a mouse and a telephone into a single compact hand-held device. Thus, it is convenient for users to carry the hand-held combined mouse and telephone device, and conveniently to use as a mouse when being connected to a computer system.

### BRIEF DESCRIPTION OF THE DRAWINGS

A detailed explanation of preferred embodiments of the present invention will be given, with reference to the attached drawings, for better understanding thereof to those skilled in the art:

FIG. 1 is a perspective view of a first embodiment of a hand-held combined mouse and telephone device according to the present invention;

FIG. 2 is a block diagram of the first embodiment of the circuit configuration of the hand-held combined mouse and telephone device as shown in FIG. 1;

FIG. 3 is a block diagram of a mouse interface circuitry of the first embodiment;

FIG. 4 illustrates the hand-held combined mouse and telephone device being applied to a host computer;

FIG. 5 is a block diagram of a second embodiment of the circuit configuration of the hand-held combined mouse and telephone device;

FIG. 6 is a perspective view of a third embodiment of the hand-held combined mouse and telephone device;

FIG. 7 is a block diagram of the third embodiment of the circuit configuration of the hand-held combined mouse and telephone device as shown in FIG. 6;

FIG. 8 is a perspective view of a fourth embodiment of the hand-held combined mouse and telephone device;

FIG. 9 is a block diagram of the fourth embodiment of the circuit configuration of the hand-held combined mouse and telephone device as shown in FIG. 8; and

FIG. 10 illustrates the hand-held combined mouse and telephone device of FIG. 8 in an open condition.

### DETAILED DESCRIPTION OF THE PREFERRED EMBODIMENTS

In the descriptions of the figures below, identical reference symbols designate mutually corresponding structural parts of functional blocks.

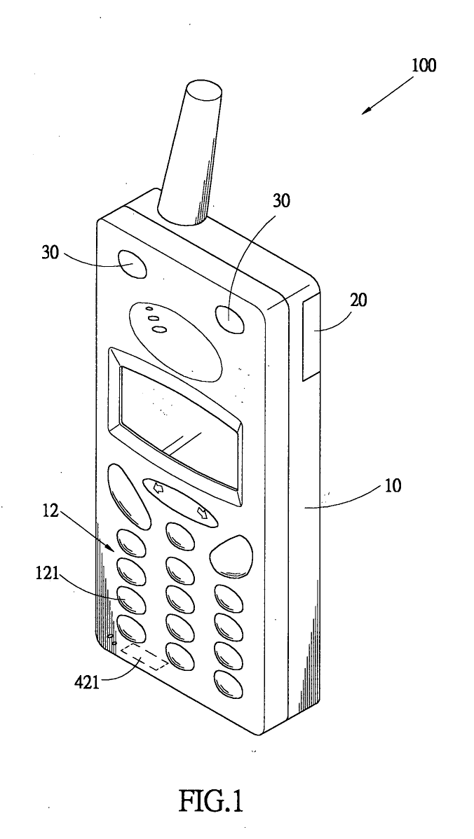

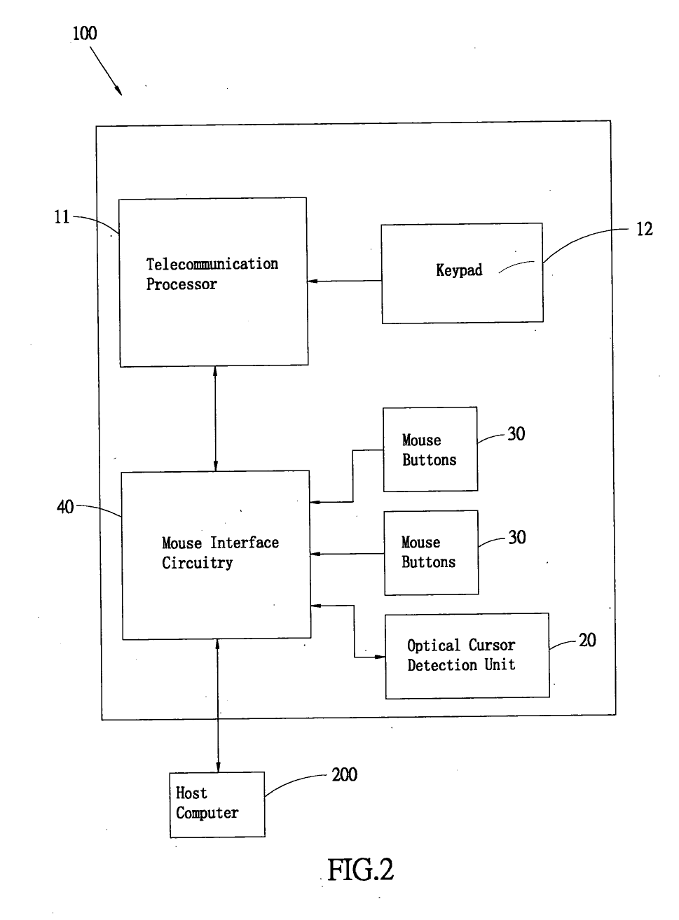

With reference to FIG. 1 and FIG. 2, a hand-held combined mouse and telephone device 100 comprises a telephone body 10, an optical cursor detection unit 20, a plurality of mouse buttons 30 and a mouse interface circuitry 40. A telecommunication processor 11 is disposed inside the telephone body 10 to control and process the telephone signals. A keypad 12 is located on the telephone body 10 for generating input signals in response to manual entry on the keypad to command the device 100 to perform corresponding communication function. A press key 121 of the keypad 12 is designed to be a mouse mode switch for alternatively switching the mouse mode on and off.

The optical cursor detection unit 20 is positioned on back of the telephone body 10, through which the mouse displacement signals of the hand-held combined mouse and telephone device 100 are detected and transmitted to the mouse interface circuitry 40 when the telephone body 10 is placed and moved on a pad, so that, the device 100 is operated in a mouse mode. The mouse buttons 30 are disposed on the front surface of the telephone body 10 for generating input signals corresponding to manual press on the mouse buttons. The input signals generated from the mouse buttons 30 are transmitted to the mouse interface circuitry 40 to control the cursor manipulation when the hand-held combined mouse and telephone device 100 is operated in the mouse mode.

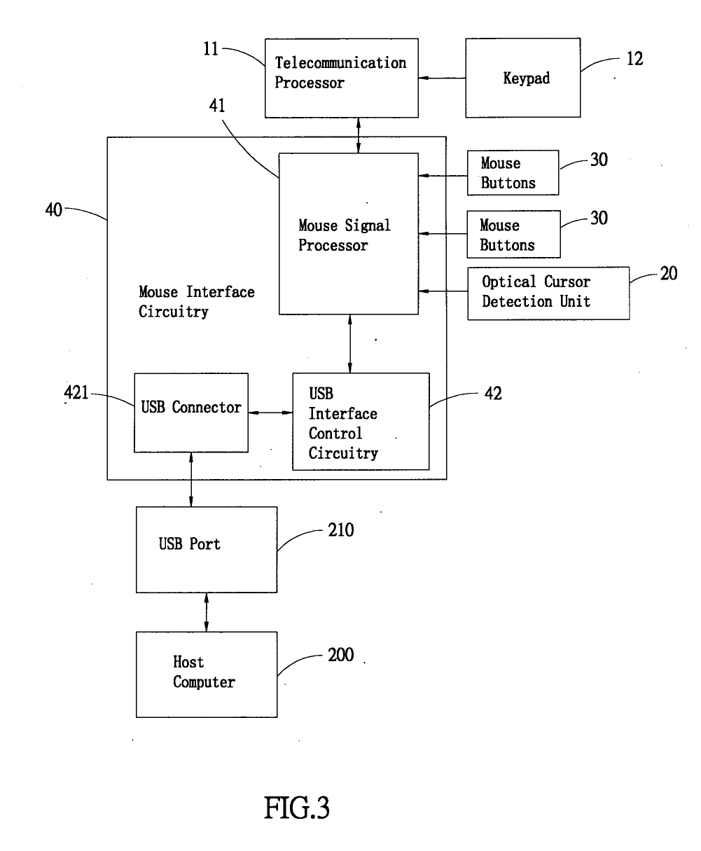

Referring to FIG. 3, the mouse interface circuitry 40 disposed inside the telephone body 10 is written into compatible mouse interface firmware. The interface standard of the mouse interface circuitry 40 is adapted to various industry mouse interface standards, for example, PS/2, RS232 etc. In this preferred embodiment, the interface of the mouse interface circuitry 40 applies USB (Universal Serial Bus) transmission interface standard. The mouse interface circuitry 40 comprises a mouse signal processor 41 and a USB interface control circuitry 42. The mouse signal processor 41 connects to the telecommunication processor 11. Thus, the telecommunication processor 11 controls and activates the mouse interface circuitry 40 through the press manipulation of the press key 121 of the keypad 12. For example, when the press key 121 is pressed for a first time, the telecommunication processor 11 activates the mouse interface circuitry 40, so the hand-held combined mouse and telephone device 100 is operated in the mouse mode. Thereafter, when the key is depressed again, the mouse interface circuitry 40 is inactivated, and the mouse mode of the hand-held combined mouse and telephone device 100 is off, while the telephone mode is on.

The optical cursor detection unit 20 and the mouse buttons 30 are connected to the mouse signal processor 41. The mouse signal processor 41 receives and processes the displacement signals from the optical cursor detection unit 20 and the input signal from the mouse buttons 30. The mouse signal processor 41 then outputs the displacement signals and the input signals to a host computer 200 through the USB interface control circuitry 42. The cursor displacement is thus controlled.

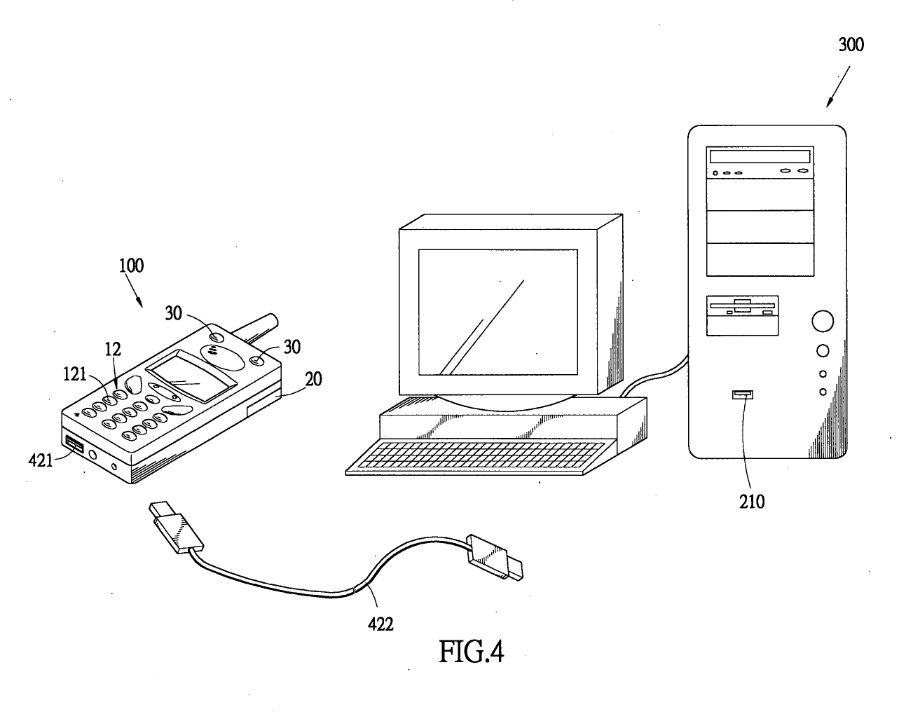

Now referring to FIG. 3 in conjunction with FIG. 4, the USB interface control circuitry 42 is coupled with the mouse signal processor 41, so as to receive the mouse displacement signals from the optical cursor detection unit 20 and the input signals from the mouse buttons 30 and converts the signals into USB standard. The USB interface control circuitry 42 connects to a USB connector 421 disposed on peripheral sides of the telephone body 10. The USB connector 421 connects to a USB port 210 provided at the host computer 200 through a USB cable 422. Therefore, the mouse displacement signal and the input signal are transmitted to the host computer 200 through the USB connector 421, the USB cable 422 and the USB port 210. The host computer 200 thus can perform the mouse function corresponding to the mouse movement and the press manipulations on the mouth buttons 30. According to the present invention, the host computer 200 may be a desktop computer, a notebook computer or a tablet computer etc.

As shown in FIG. 4, when the hand-held combined mouse and telephone device 100 is connected to the host computer 200, the press key 121 of the keypad 12 is pressed to activate the mouse mode of the hand-held combined mouse and telephone device 100, and the mouse interface circuitry 40 transmits the mouse displacement signals and the input signals to the host computer 200, so the hand-held combined mouse and telephone device 100 is operated as a common computer mouse. If the hand-held combined mouse and telephone device 100 has a telephone in or is needed to telephone off, the press key 121 is pressed again to switch the mouse mode to the telecommunication mode, during which the cursor is halted on the screen of the host computer display. After the telecommunication is over, the press key 121 is pressed again to switch the mouse mode on.

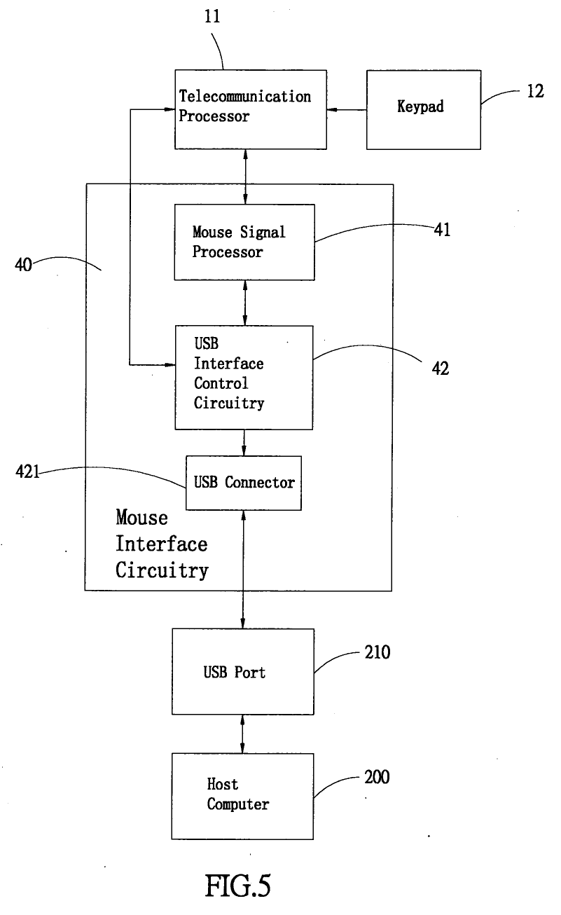

FIG. 5 shows a second preferred embodiment of the hand-held combined mouse and telephone device 100 in accordance with the present invention. The telecommunication processor 11 respectively couples with the USB interface control circuitry 42 and the mouse signal processor 41 of the mouse interface circuitry 40. When the press key 121 switches the mouse mode off, that is, the hand-held combined mouse and telephone device 100 is functioned as a mobile telephone. In the telephone mode, with the USB connector 421 of the USB interface control circuitry 42, the telecommunication processor 11 of the hand-held combined mouse and telephone device 100 connects to the host computer 200 or a memory card reader or a digital camera or an MP3 player or other multimedia device etc. So the hand-held combined mouse and telephone device 100 provides image data, audio data, newsletter, or address book data transmission interfaces for data uploading/downloading. When the press key 121 is pressed again, the mouse mode is activated again, and the mouse interface circuitry 40 transmits the mouse displacement signals and input signals again to the host computer 200, meanwhile the data transmission interface of the telecommunication processor 11 is automatically shut off.

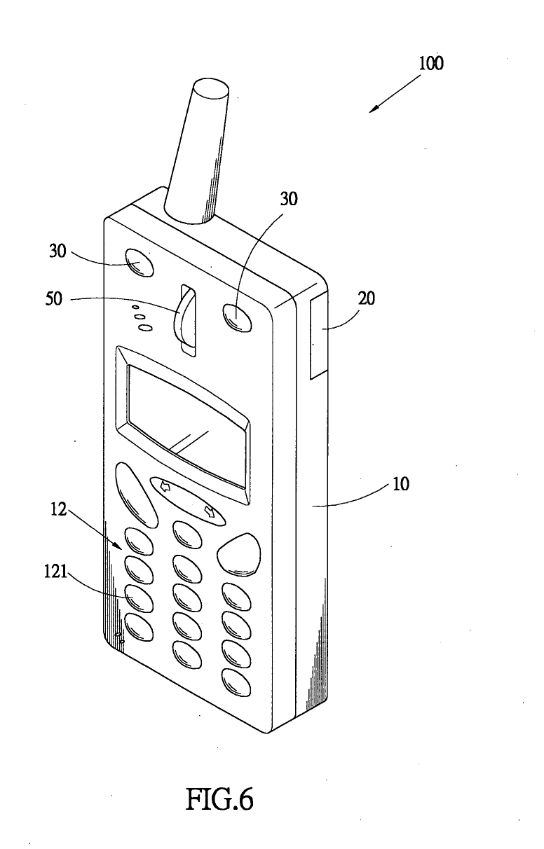

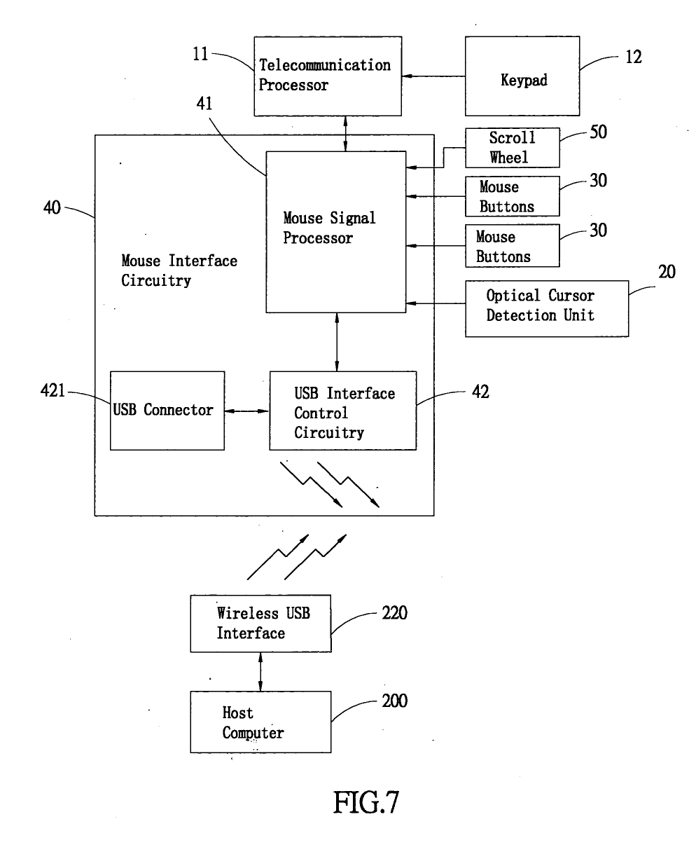

A third preferred embodiment of the hand-held combined mouse and telephone device 100 is shown in FIG. 6 and FIG. 7. The hand-held combined mouse and telephone device 100 further comprises a scroll wheel 50 disposed on a surface of the telephone body 10. According to this preferred embodiment, the scroll wheel 50 is disposed on the front surface of the telephone body 10. The scroll wheel 50 is connected to the mouse signal processor 41 of the mouse interface circuitry 40, so the scroll wheel 50 provides for an increased function and ease of use when the hand-held combined mouse and telephone device 100 is used with the host computer 200 as a common computer mouse. That is to say, the scroll wheel 50 outputs scrolling signals to the mouse signal processor 41, and then the scrolling signals are processed by the mouse signal processor 41 and transmitted to the host computer 200 through the USB connector 421 of the USB interface control circuitry 42, thus the host computer 200 can perform the corresponding mouse scrolling function.

Referring to FIG. 7, the USB interface control circuitry 42 is a wireless USB transmission interface, and correspondingly, the host computer 200 has a wireless USB interface 220. The mouse displacement signals, the input signals from the mouse buttons 30 and the scrolling signals from the scrolling wheel 50 are transmitted to the host computer 200 through the wireless USB interface, thus, the hand-held combined mouse and telephone device 100 is operated as a wireless mouse.

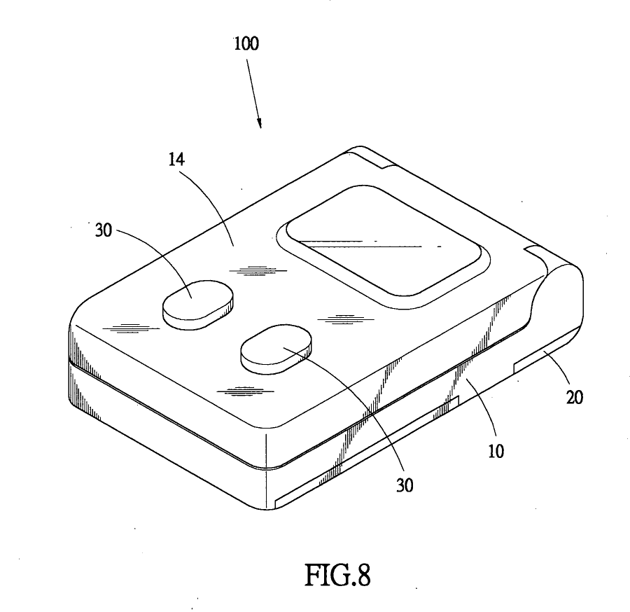

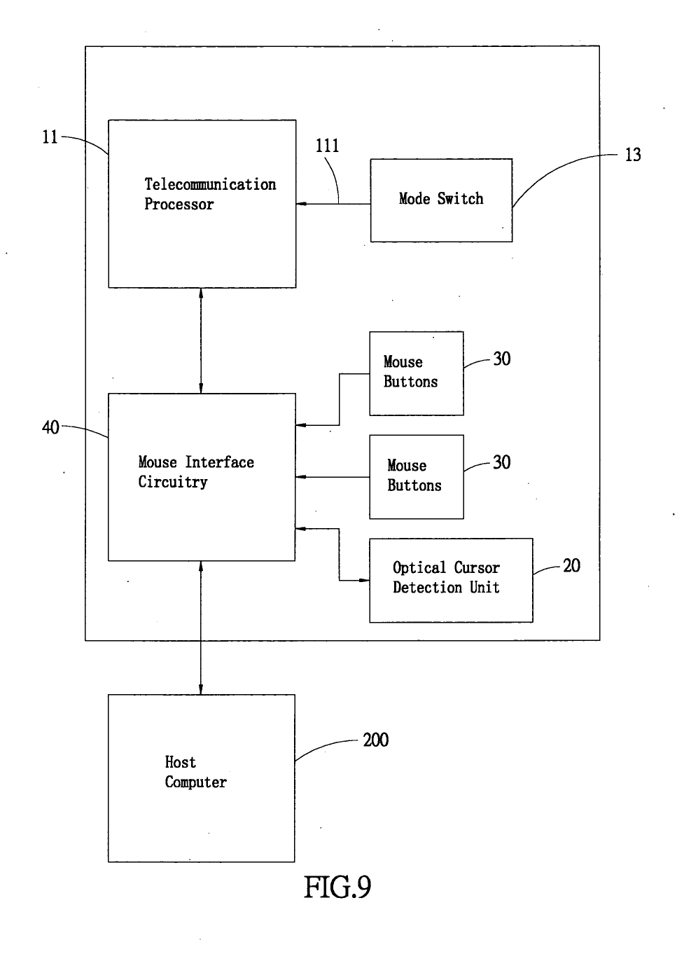

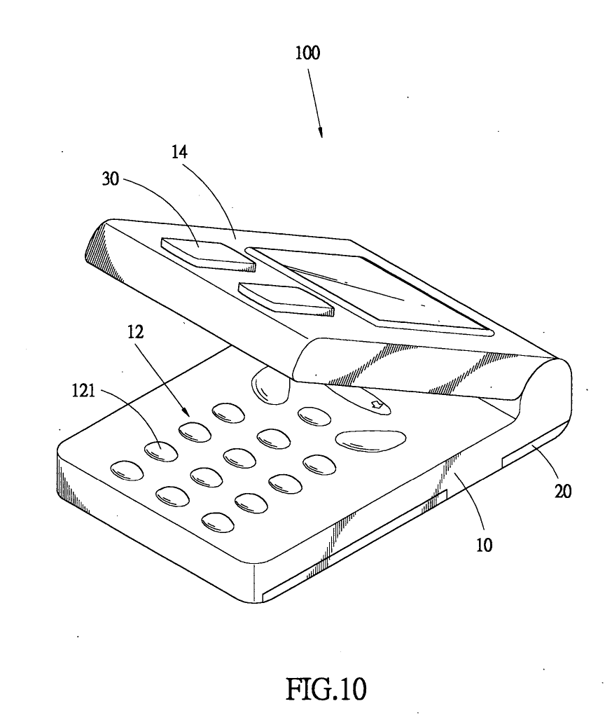

Referring to FIGS. 8, 9 and 10, a fourth preferred embodiment of the present invention is shown. The hand-held combined mouse and telephone device 100 is a flip-style phone (as shown in FIG. 8). A mode switch 13 is disposed on the telephone body 10 to detect whether an upper cover 14 of the telephone body 10 is folded so as to switch the telephone mode on and off. Mouse buttons 30 are disposed on the front surface of the upper cover 14 (as shown in FIG. 8). The mode switch 13 connects to a control pin 111 of the telecommunication processor 11 (as shown in FIG. 9). The switching signals from the mode switch 13 are transmitted through the control pin 111 to the telecommunication processor 11 so as to control whether to transmit mouse displacement signals and input signals to the host computer 200. In other words, while the mouse interface circuitry 40 is operated as a common computer mouse, once the upper cover 14 is opened (as shown in FIG. 10), the mode switch 13 generates and inputs a switching signal to the telecommunication processor 11 to switch the mouse mode of the hand-held combined mouse and telephone device 100 to the telephone mode, and simultaneously shut off the transmission of the mouse displacement signals and input signals from the mouse interface circuitry 40 to the host computer 200. At the same time, the cursor is halted on the computer display screen. After the telecommunication is over and the upper cover 14 is folded to the telephone body 10, the mode switch 13 is depressed by the upper cover 14 and switches the mouse mode on, the mouse interface circuitry 4o is activated again to transmit the mouse displacement signals and the input signals again to the host computer 200. Thus, the hand-held combined mouse and telephone device 100 is activated to be used as a common mouse.

Although preferred embodiments of the present invention have been described in detail hereinabove, it should be clearly understand that many variations and/or modifications of the basic inventive concepts herein taught which may appear to those skilled in the present art will fall within the spirit and scope of the present invention, as defined in the appended claims.

What is claimed is:

1. A hand-held combined mouse and telephone device comprising:
a telephone body having a telecommunication processor and a keypad, the telecommunication processor controlling and processing telephone signals, the keypad generating input signals in response to manual entry on the keypad;
an optical cursor detection unit being disposed on the back of the telephone body, the optical cursor detection unit detecting the displacement signal of the telephone body when the telephone body is placed and moved on a pad and outputting displacement signal;
a plurality of mouse buttons being disposed on the telephone body for generating input signals corresponding to manual press on the mouse buttons; and
a mouse interface circuitry connecting to the telecommunication processor, the optical cursor detection unit, and the mouse buttons, and the mouse interface circuitry being adapted to connecting a host computer, the mouse interface circuitry controlling the optical cursor detection unit and the mouse buttons to be alternatively switched on and off, and receiving the displacement signals from the optical cursor detection unit and the input signals from the mouse buttons, the telecommunication processor controlling the mouse interface circuitry to be switched on and off so as to control the transmission of the displacement signals from the optical cursor detection and the input signals from the mouse buttons to the host computer.

2. The hand-held combined mouse and telephone device as claimed in claim 1, wherein said telephone body is provided with a mode switch being connected to a control pin of the telecommunication processor to control the mouse interface circuitry to be switched on and off.

3. The hand-held combined mouse and telephone device as claimed in claim 1, wherein a scroll wheel is disposed on the telephone body.

4. The hand-held combined mouse and telephone device as claimed in claim 1, wherein the mouse interface circuitry further comprises a mouse signal processor being connected to the telecommunication processor and a USB interface control circuitry being connected to the mouse signal processor and the host computer.

5. The hand-held combined mouse and telephone device as claimed in claim 1, wherein the mouse interface circuitry further comprises a mouse signal processor being connected to the telecommunication processor and a USB interface control circuitry being connected to the mouse signal processor, the telecommunication processor, and the host computer.

6. The hand-held combined mouse and telephone device as claimed in claim 4, wherein further comprises a USB connector connecting the USB interface control circuitry.

7. The hand-held combined mouse and telephone device as claimed in claim 4, wherein the USB interface control circuitry is a wireless USB interface.

8. The hand-held combined mouse and telephone device as claimed in claim 5, wherein further comprises a USB connector connecting the USB interface control circuitry.

9. The hand-held combined mouse and telephone device as claimed in claim 5, wherein the USB interface control circuitry is a wireless USB interface.

10. The hand-held combined mouse and telephone device as claimed in claim 1, wherein a press key of the keypad of the telephone body controls the mouse interface circuitry to be switched on and off.
